(19) United States
(12) Patent Application Publication
(10) Pub. No.: US 2026/0091707 A1
(43) Pub. Date: Apr. 2, 2026

(54) COLD PLATES FOR LIQUID COOLING SYSTEMS, METHODS FOR USE THEREOF, AND VEHICLES INCLUDING THE SAME

(71) Applicant: GM GLOBAL TECHNOLOGY OPERATIONS LLC, Detroit, MI (US)

(72) Inventors: Andrew Clay Bobel, Troy, MI (US); Diptak Bhattacharya, Royal Oak, MI (US); William Yu Chen, Troy, MI (US); Masoud M. Pour, Washington, MI (US)

(73) Assignee: GM GLOBAL TECHNOLOGY OPERATIONS LLC, Detroit, MI (US)

(21) Appl. No.: 18/903,816

(22) Filed: Oct. 1, 2024

(51) Int. Cl. B60L 58/26; H01M 10/625; F28D 21/00

(52) U.S. Cl. CPC B60L 58/26; H01M 10/625; F28D 2021/008; F28F 2275/06

(57) ABSTRACT

Cold plates for liquid cooling systems, methods for the cold plates, and vehicles including the cold plates are provided. The methods include welding together a first substrate and a second substrate with weld lines, inflating portions of at least the second substrate between the weld lines to form a network of channels between the first substrate and the second substrate and thereby produce a cold plate, installing the cold plate to be in thermal contact with an apparatus that produces heat during operation thereof, wherein the apparatus includes a housing and the cold plate is welded to a portion of the housing or defines a portion of the housing, and coupling the cold plate to a liquid cooling system configured to supply a coolant to the network of channels to remove the heat from the apparatus.

### INTRODUCTION

The technical field generally relates to liquid cooling systems, and more particularly relates to liquid cooling systems having integrated cooling plates.

Electrical systems within vehicles, such as hybrid, electric, and fuel cell vehicles, have advanced in complexity and power usage, relying in part on large batteries to store energy. Energy flowing into the battery or being discharged from the battery to power the vehicle and its accessories causes heating in the battery cells, where the higher the current flow, the greater the heating effect. Unfortunately, the increased heat in the battery assembly can disadvantageously impact its performance. Cooling systems are therefore provided in battery packs to maintain a particular operating temperature or temperature range of the battery. These cooling systems, however, can present high manufacturing costs and can add a significant amount of weight to the battery.

Accordingly, there is an ongoing desire for improved cooling systems and methods. Furthermore, other desirable features and characteristics of the present disclosure will become apparent from the subsequent detailed description and the appended claims, taken in conjunction with the accompanying drawings and the foregoing introduction.

### SUMMARY

A method is provided that, in one example, includes welding together a first substrate and a second substrate with weld lines, inflating portions of at least the second substrate between the weld lines to form a network of channels between the first substrate and the second substrate and thereby produce a cold plate, installing the cold plate to be in thermal contact with an apparatus that produces heat during operation thereof, wherein the apparatus includes a housing and the cold plate is welded to a portion of the housing or defines a portion of the housing, and coupling the cold plate to a liquid cooling system configured to supply a coolant to the network of channels to remove the heat from the apparatus.

In various examples, installing the cold plate includes welding the cold plate to a panel of the housing of the apparatus. In various examples, the apparatus is a rechargeable energy storage system (RESS) of a vehicle that includes at least a first battery module, and the cold plate is welded to a floor panel of the housing of the RESS or to a housing of the first battery module.

In various examples, the cold plate defines a panel of the housing of the apparatus. In various examples, the apparatus is a rechargeable energy storage system (RESS) of a vehicle, and the cold plate defines a floor panel of the housing of the RESS. In various examples, the cold plate defines a cover panel of the housing of the RESS.

In various examples, the method includes removing non-inflated areas of the second substrate prior to installing the cold plate.

In various examples, the method includes providing a high thermal conductivity layer on a side of the first substrate opposite the network of channels to promote thermal transfer between adjacent channels of the network of channels.

A cold plate is provided that, in one example, includes a first substrate and a second substrate welded together with weld lines, wherein portions of at least the second substrate between the weld lines are deformed to be raised relative to the first substrate and thereby form a network of channels between the first substrate and the second substrate, wherein the cold plate is configured to be installed in thermal contact with an apparatus that produces heat during operation thereof, wherein the apparatus includes a housing and the cold plate is configured to be welded to a portion of the housing or define a portion of the housing, wherein the first substrate and the second substrate are formed of steel, an inlet configured to provide access to the network of channels, receive a coolant from a liquid cooling system, and direct the coolant to the network of channels to remove the heat from the apparatus, and an outlet configured to provide access to the network of channels, receive the coolant from the network of channels, and direct the coolant to the liquid cooling system.

In various examples, the cold plate is configured to be welded to a panel of the housing of the apparatus. In various examples, the apparatus is a rechargeable energy storage system (RESS) of a vehicle that includes at least a first battery module, and the cold plate is configured to be welded to a floor panel of the housing of the RESS of to a housing of the first battery module.

In various examples, the cold plate is configured to define a panel of the housing of the apparatus. In various examples, the apparatus is a rechargeable energy storage system (RESS) of a vehicle, and the cold plate is configured to define a floor panel of the housing of the RESS. In various examples, the cold plate is configured to define a cover panel of the housing of the RESS.

In various examples, the second substrate does not include non-inflated areas outside of the weld lines.

In various examples, a high thermal conductivity layer is provided on a side of the first substrate opposite the network of channels that is configured to promote thermal transfer between adjacent channels of the network of channels.

A vehicle is provided that, in one example, includes a rechargeable energy storage system (RESS) having at least one battery and a housing enclosing the at least one battery, a liquid cooling system having a coolant circuit, a pump configured to propel a coolant through the coolant circuit, and a heat exchanger for removing heat from the coolant, and a cold plate in thermal contact with the RESS and fluidically coupled with the coolant circuit. The cold plate includes a first substrate and a second substrate welded together with weld lines, wherein portions of at least the second substrate between the weld lines are deformed to be raised relative to the first substrate and thereby form a network of channels between the first substrate and the second substrate, wherein the cold plate is configured to be welded to a portion of the housing or define a portion of the housing of the RESS, wherein the first substrate and the second substrate are formed of steel, an inlet configured to provide access to the network of channels, receive the coolant from the liquid cooling system, and direct the coolant to the network of channels to remove heat from the at least one battery during operation of the RESS, and an outlet configured to provide access to the network of channels, receive the coolant from the network of channels, and direct the coolant to the liquid cooling system.

In various examples, the cold plate is configured to be welded to a panel of the housing of the RESS of to a housing of a first battery module of the RESS.

In various examples, the cold plate is configured to define a floor panel or a cover panel of the housing of the RESS.

In various examples, the second substrate does not include non-inflated areas outside of the weld lines and the cold plate includes a high thermal conductivity layer disposed between adjacent channels of the network of channels that is configured to promote thermal transfer between the adjacent channels.

### BRIEF DESCRIPTION OF THE DRAWINGS

The exemplary embodiments will hereinafter be described in conjunction with the following drawing figures, wherein like numerals denote like elements, and wherein:

FIG. 1 includes a functional block diagram representing a vehicle having a rechargeable energy storage system (RESS) and a liquid cooling system in accordance with an example;

FIG. 2 includes a cross-sectional view representing an exemplary portion of an RESS having a cold plate in accordance with an example;

FIG. 3 includes a top view of the cold plate of FIG. 2 in accordance with an example;

FIG. 4 includes cross-sectional views representing a portion of a cold plate before and after inflation of a welded track to form raised areas defining channels for coolant flow in accordance with an example;

FIG. 5 includes cross-sectional views representing a portion of a cold plate before and after inflation of a welded track to form raised areas defining channels for coolant flow, wherein portions of the cold plate have been removed for weight savings in accordance with an example;

FIG. 6 includes a cross-sectional view representing a cold plate that defines a cover panel of a housing of a RESS in accordance with an example;

FIG. 7 includes a cross-sectional view representing a cold plate that defines a floor panel of a housing of a RESS in accordance with an example;

FIG. 8 includes a flowchart illustrating a method for producing a cold plate for a liquid cooling system in accordance with an example; and

FIG. 9 includes a cross-sectional view representing an exemplary portion of an RESS having a cold plate including a high thermal conductivity layer in accordance with an example.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

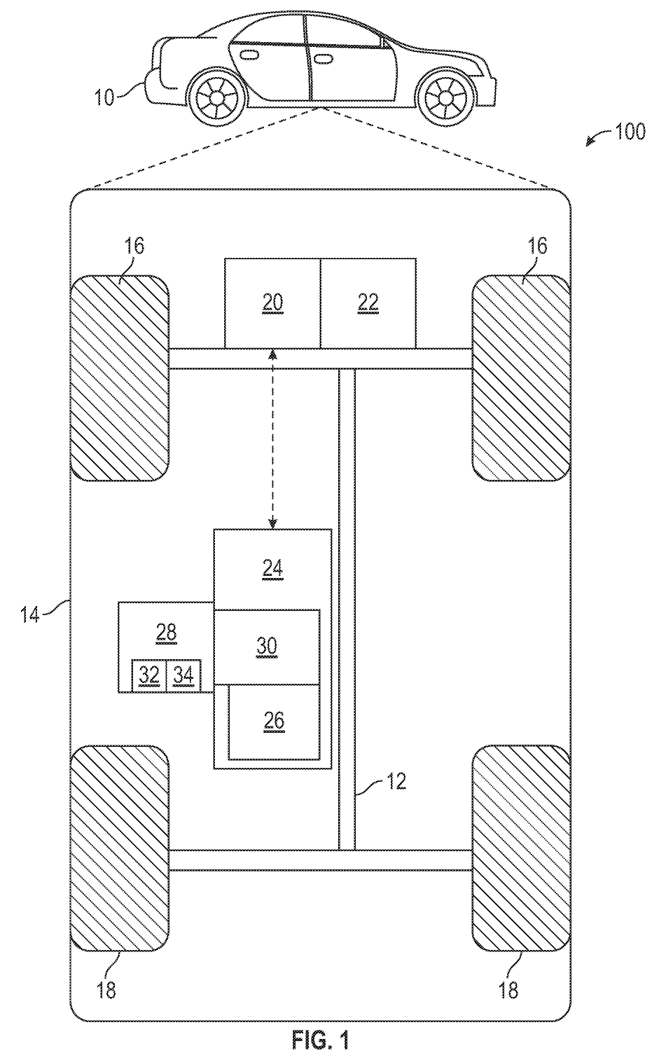

FIG. 1 illustrates a vehicle 10, according to an example. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

The vehicle 10 further includes a propulsion system 20 having an electric motor and, optionally, an internal combustion engine (e.g., a gasoline or diesel fueled combustion engine). A transmission system 22 transmits power from the propulsion system 20 to the wheels 16, 18 according to selectable speed ratios. According to various examples, the transmission system 22 may include a step-ratio automatic transmission, a continuously-variable transmission, or other appropriate transmission. A rechargeable energy storage system (RESS) 24 is provided that includes a battery, battery module, or set of batteries/battery modules 26 for storing and supplying electrical power for the electric motor and/or other systems connected to one or more electrical grids or systems onboard the vehicle 10. The electrical system(s) may couple the RESS 24 to one or more accessories of the vehicle 10, such as audio devices, lighting devices, etc. In some examples, the battery modules 26 may include high-capacity lithium-ion batteries or other types of rechargeable batteries such as nickel-metal hydride (NiMH) or solid-state batteries.

The vehicle 10 further includes a liquid cooling system 28 configured to remove heat produced by the battery modules 26 during operation of the RESS 24. More particularly, the liquid cooling system 28 is configured to flow a coolant through a coolant loop that includes one or more cold plates 30 that are in thermal contact with the battery modules 26 to remove heat from the battery module 26. The cold plates 30 include a network of channels or passages in thermal contact with, and typically disposed within or adjacent to, the battery module 26. The liquid cooling system 28 may include a pump 32 configured to circulate the coolant through the coolant loop, and a heat exchanger 34 configured to remove heat from the coolant. The heat exchanger 34 may include passages or channels that are part of the coolant loop, or may be separate from but in thermal contact with the coolant loop. Various coolants may be used in the liquid cooling system 28 including, but not limited to, various low conductivity coolants. In some examples, the coolant may include a water-based solution with additives, such as a mixture of water and antifreeze (such as ethylene glycol or propylene glycol).

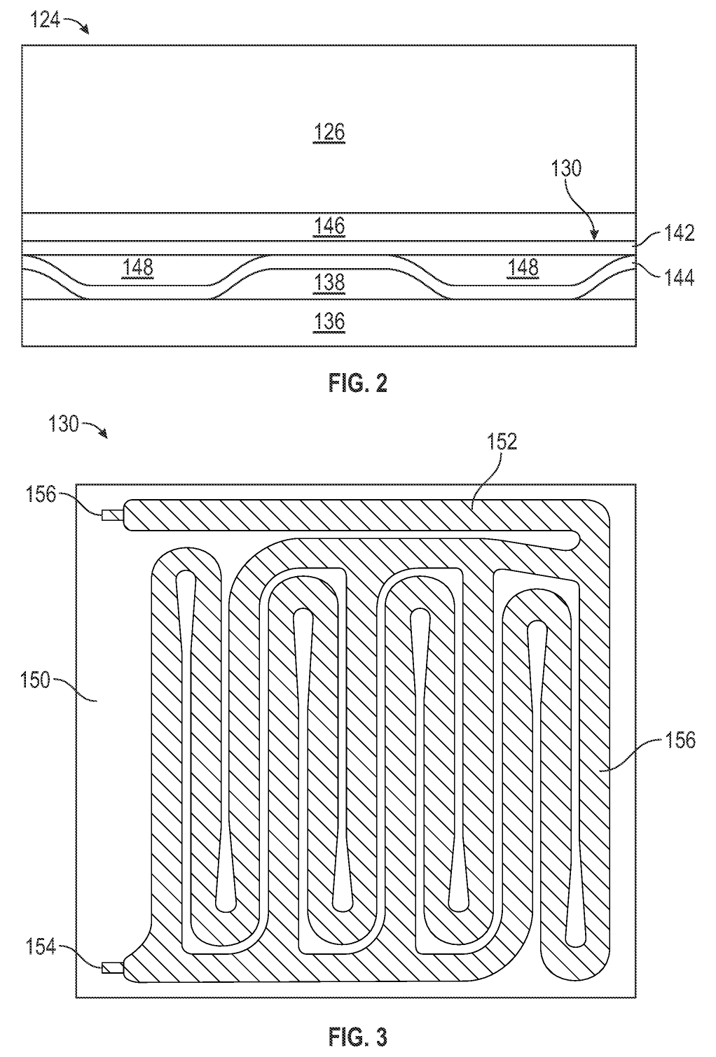

FIGS. 2-7 illustrate various nonlimiting examples of cold plates, such as the cold plate 30. It should be noted that these examples are merely for illustrative purposes and the cold plate 30 of FIG. 1 may have other configurations, including various combinations of the components represented in FIGS. 2-7.

For convenience, consistent reference numbers are used throughout FIGS. 2-7 to identify the same or functionally related/equivalent elements, but with a numerical prefix (1, 2, or 3, etc.) added to distinguish the particular example from other examples of the of the figures. In view of similarities between the examples, the following discussion of FIGS. 2-7 will focus primarily on aspects of the examples that differ from the other examples in some notable or significant manner. Other aspects of the examples not discussed in any detail can be, in terms of structure, function, materials, etc., essentially as was described for one or more of the other examples, including the example of FIG. 1.

Referring now to FIG. 2, a cross-sectional view of an exemplary portion of an RESS 124 is represented that illustrates certain layers thereof. Specifically, FIG. 2 shows a portion of a battery module 126, a floor panel 136 defining a portion of a housing of the RESS 124, and a cold plate 130 therebetween. The cold plate 130 includes a first substrate 142 and a second substrate 144 with channels 148 formed therebetween for the flow of coolant. In some examples, a layer of supporting material 138 (e.g., a polymer foam) may optionally be disposed between portions of the cold plate 130 and the floor panel 136 to provide support in cavities between the channels 148. In some examples, a layer of a thermal interface material (TIM) 146 may be disposed between the battery module 126 and the cold plate 130.

In some alternative examples, the floor panel 136 may alternatively be a portion of a housing of the battery module 126. In yet other examples, the cold panel 136 may define a portion of the housing of the battery module 126.

FIG. 3 is a top view of the cold plate 130. As represented, the cold plate 130 includes raised areas 152 that define the channels 148, and non-raised areas 150. The channels 148 form a network for passage of the coolant through the cold plate 130. An inlet 154 and an outlet 156 are disposed at ends of the network, and configured to be fluidically coupled to the remainder of the coolant loop and thereby allow the coolant to enter and exit the channels 148. It should be understood that the characteristics of the channels 148 represented in FIG. 3 including, for example, the quantity, paths, sizes, and shapes of the channels 148, are merely exemplary and that the cold plate 130 may include other configurations. In some examples, the channels 148 may be about 15 to about 60 mm wide in a direction perpendicular to the flow of the coolant.

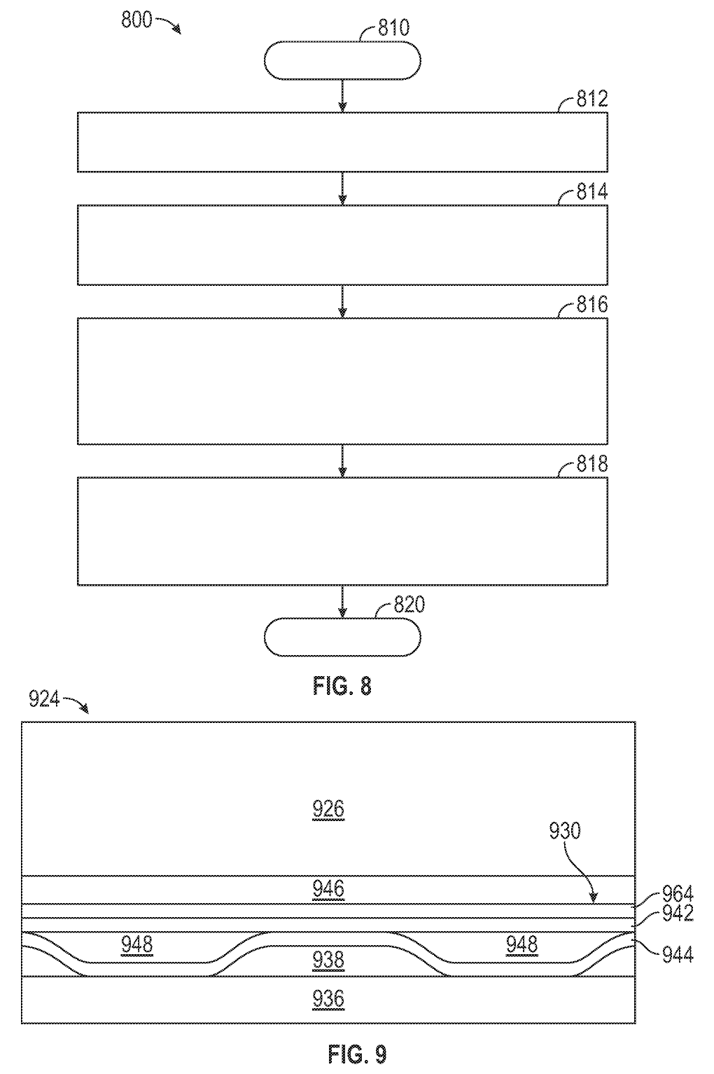

Conventionally, cold plates for an RESS have been formed by stamping and brazing two metal substrates (e.g., aluminum sheets) together. The cold plates could then be secured with fasteners in fixed positions relative to a housing of the RESS, such as a floor panel. In contrast, the cold plates disclosed herein may be formed without stamping or brazing. Specifically, the method of forming the cold plate may include welding a plurality of weld lines to physically connect a pair of substrates, and then inflating areas between the weld lines to for the channels of the cold plate. The cold plate may then be permanently integrated with a housing of an RESS, for example, by welding. As a nonlimiting example, FIG. 8 includes a flowchart illustrating an exemplary method 800. As can be appreciated in light of the disclosure, the order of operation within the method 800 is not limited to the sequential execution as illustrated in FIG. 8, but may be performed in one or more varying orders as applicable and in accordance with the present disclosure.

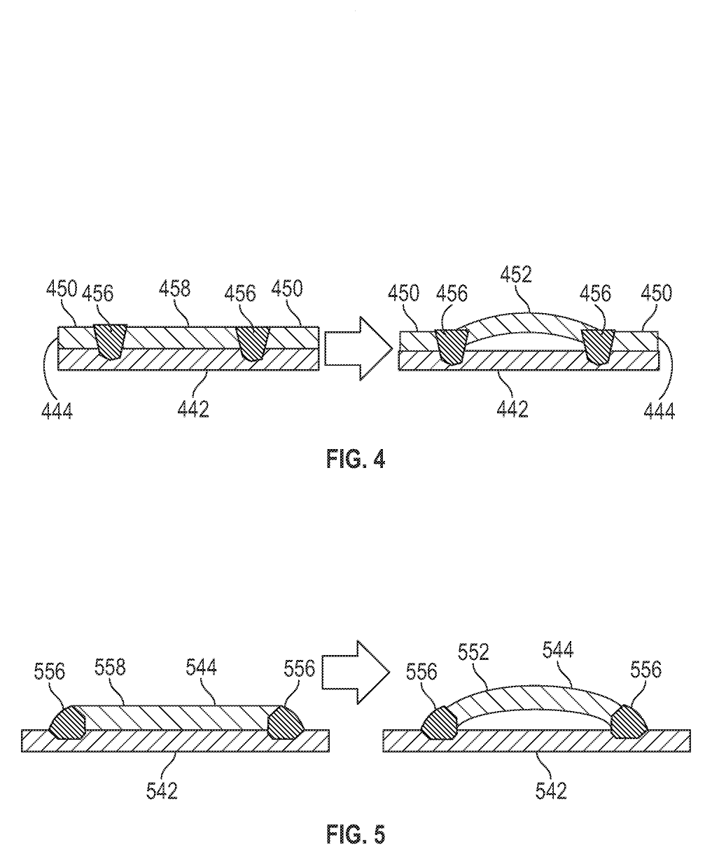

In one example, the method 800 may start at 810. At 812, the method 800 may include welding together a first substrate 442 and a second substrate 444, or to a plurality of substrates, with a plurality of weld lines 456. Various welding methods may be used including, but not limited to, certain laser welding, resistance seam welding, and friction stir welding processes. Notably, the plurality of weld lines 456 forms a track 458. At 814, the method 800 may include inflating regions between the weld lines 456 (i.e., the track 458) to form raised areas 452 that define a network of channels between the first substrate 442 and the second substrate 444 and thereby produce a cold plate. Notably, regions outside of the weld lines 456 define non-raised areas 450. FIG. 4 includes cross-sectional views illustrating a portion of a cold plate before and after inflation of the track 458 to form the raised areas 452. At 816, the method 800 may include installing the cold plate to be in thermal contact with an apparatus that produces heat during operation thereof, such as a battery, such as within the RESS 24 of FIG. 1. In various examples, the apparatus includes a housing and the cold plate may be integrated into the housing. For example, the cold plate may be welded to a portion of the housing. As another example, the cold plate may define a portion of the housing, such as a floor plate, and thereby define at least a portion of the exterior surfaces of the RESS. In some examples, the cold plate may define a structural support and/or protective element of the RESS. For examples in which the cold plate define a structural support and/or protective element of the RESS, the cold plate may be secured to other portions of the RESS by various methods such as with fasteners or welds. For example, the cold plate may be welded to crossbars or halo/walls of the RESS and define a floor panel of a housing of the RESS. In some examples, the cold plate may be integrated with a battery module within the RESS. For example, the cold plate may be welded to structural components to cover a portion of a battery module. At 818, the method 800 may include coupling the cold plate to a liquid cooling system configured to supply a coolant to the network of channels to remove the heat from the apparatus. The method 800 may end at 820.

Various methods may be used to inflate the track 458. In some examples, the first and second substrates 442, 444 may be positioned between a pair of plates (not shown), with at least one of the plates having cavities corresponding in size and shape to the desired channels of the cold plate. A pressurized fluid may then be forced into the track 458 between at least the first and second substrates 442, 444 to inflate portions of the first substrate 442, the second substrate 444, or both to form the channels. Nonlimiting exemplary processes for inflating the track 458 are disclosed in U.S. Patent No. 11,549,626 to Sachdev et al., an entirety of which is incorporated herein by reference.

In some examples, some or all of non-raised areas of a cold plate may be removed to reduce the weight of the cold plate. For example, FIG. 5 includes cross-sectional views illustrating a portion of a cold plate before and after inflation. The cold plate includes a first substrate 542, a second substrate 544, and weld lines 556 securing the first and second substrates 542, 544 together. In this example, non-raised areas of the second substrate 544 outside of the weld lines 556 (that is, portions that do not define the track 558) have been removed prior to inflation of the track 558. Various methods may be used to remove the non-raised areas such as, but not limited to, certain trimming operations (e.g., die cutting, slitting, or shearing), laser cutting, etc. In some examples, the weld lines 556 may be lap or fillet welds to promote durability of ends of the track 558.

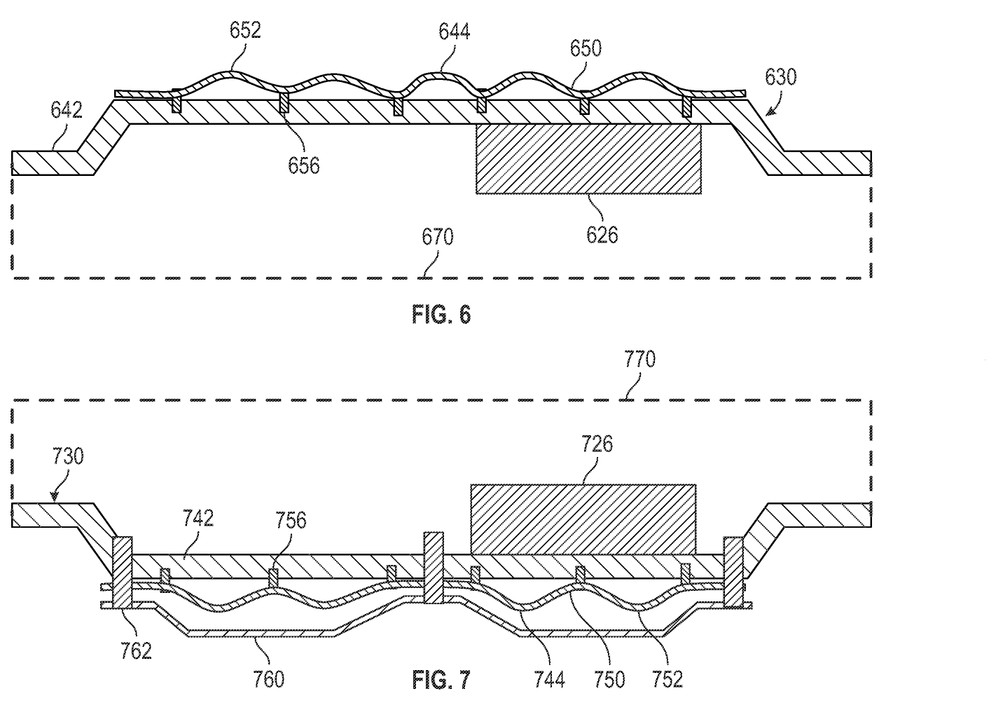

Referring now to FIGS. 6 and 7, examples of cold plates 630 and 730 are represented that define a portion of housings of RESSs. In these example of FIG. 6, a cold plate 630 includes a first substrate 642 and a second substrate 644 that are coupled by weld lines 656. The first substrate 642 is configured to function as a cover panel enclosing a top portion of an RESS for a vehicle, such as the RESS 24 of the vehicle 10. In addition, the first substrate 642 is in thermal contact with one or more battery modules 626. The second substrate 644 includes raised areas 652 that define channels for receiving a coolant and thereby removing heat from the battery modules 626, and non-raised areas 650 therebetween. In some examples, the first substrate 642 may undergo a stamping process to provide a specific shape to define the cover panel. In such examples, the second substrate 644 may be welded to the first substrate 642 prior to or subsequent to the stamping process. The cold plate 630 may be secured to a remainder of a housing 670 of the RESS, such as with fasteners or welds.

In the example of FIG. 7, a cold plate 730 includes a first substrate 742 and a second substrate 744 that are coupled by weld lines 756. The first substrate 742 is configured to function as a floor panel enclosing a bottom portion of an RESS for a vehicle, such as the RESS 24 of the vehicle 10. In addition, the first substrate 742 is in thermal contact with one or more battery modules 726. The second substrate 744 includes raised areas 752 that define channels for receiving a coolant and thereby removing heat from the battery modules 726, and non-raised areas 750 therebetween. The cold plate 730 may optionally include a skid plate 760 configured to protect the second substrate 744 from road debris and the like. The skid plate 760 may be welded to the remainder of the cold plate 730, or may be secure with fasteners 762 or other coupling devices. In some examples, the first substrate 742 may undergo a stamping process to provide a specific shape to define the floor panel. In such examples, the second substrate 744 may be welded to the first substrate 742 prior to or subsequent to the stamping process. The cold plate 730 may be secured to a remainder of a housing 770 of the RESS, such as with fasteners or welds.

In FIGS. 6 and 7, the first substrates 642, 742 and the second substrates 644, 744 may have different functions. In some examples, the first substrates 642, 742 may be configured to be sufficiently rigid and strong to function as portions of the housing of the RESS. This may be achieved by providing the first substrates 642, 742 with a sufficient thickness and/or by forming the first substrates 642, 742 from materials that provide the necessary support for the housing. For example, the first substrates 642, 742 may have at thickness of about 0.2 mm or greater, such as about 0.3 to about 1.5 mm. As another example, the first substrates 642, 742 may be formed of a high strength steel.

In some examples, the second substrates 644, 744 may be configured to be inflated in areas between the weld lines 656, 756 to form the channels. This may be achieved by providing the second substrates 644, 744 with thicknesses and/or by forming the second substrates 644, 744 from materials that are sufficiently malleable to be inflated while also being sufficiently strong and durable to function as the channels after the inflation process (e.g., operate at the operating pressures of the coolant, remain leak free, etc.). For example, the second substrates 644, 744 may have at thickness of about 0.1 mm or greater, such as about 0.1 to about 0.4 mm. As another example, the second substrates 644, 744 may be formed of a low strength steel.

In FIGS. 6 and 7, the second substrates 644, 744 are located on exterior sides of the first substrates 642, 742 relative to the interior of the housing of the RESS, and inflated to provide the cooling channels on the exterior of the housing. In other examples, the second substrates 644, 744 may be located on interior sides of the first substrates 642, 742, and inflated to provide the cooling channels on the interior of the housing. In yet other examples, the second substrates 644, 744 may define portions of housing (e.g., the cover panel or the floor panel), the first substrates 642, 742 may be rigid plates welded thereto, and the second substrates 644, 744 may be inflated to form the channels.

Although the cold plates 30, 130, 630, 730 are not limited to any particular material, in some examples, the cold plates 30, 130, 630, 730 may be formed of a material that is the same or similar to the housing material such that the cold plates 30, 130, 630, 730 may be welded to a portion of the housing, rather than secured with fasteners or the like. In various examples, the cold plates 30, 130, 630, 730 may include or be formed of various steel materials. In various examples, portions of the cold plates 30, 130, 630, 730 that are intended to define the raised areas 152, 652, 752 that is, be inflated, may include or be formed of various low strength steels (e.g., CR210, CR1, CR2, CR3, etc.). In various examples, portions of the cold plates 30, 130, 630, 730 that are intended to define the non-raised areas 150, 650, 750, that is, not be inflated, may include or be formed of various high strength steels (e.g., 420LA, DP600, 780, 980). In a specific nonlimiting example, the first substrate (e.g., the first substrates 142, 442, 542, 642, 742) may be formed of a high strength steel that is sufficiently rigid to remain unchanged during the inflation process, the second substrate (e.g., the second substrates 144, 444, 544, 644, 744) may be formed of a low strength steel configured to form the raised areas 152, 452, 552, 652, 752 during the inflation process and define fluid tight channels subsequent to the inflation process, and the remainder of the housing may be formed of a steel, such as the same high strength steel as the first substrate, such that the first substrate and adjacent portions of the housing may be welded together. This is in contrast to various existing cold plates, such as those formed of aluminum, that cannot be welded to housings formed of dissimilar materials, such as steel.

In some examples, one or more of the layers (e.g., substrates) of the cold plates 30, 130, 630, 730 may include coatings deposited thereon. For example, one or more of the layers may be formed of a steel material and include a coating thereon configured to promote corrosion resistance. In such examples, the coating may include nickel (Ni), copper (Cu), or an aluminum-silicon alloy (Al-Si). In some examples, the coatings may have a thickness of about 3 to 20 micrometers. For example, the coating may include nickel or an alloy thereof having a thickness of up to about 5 micrometers, such as about 1 to 5 micrometers, such as about 3 to 5 micrometers. As another example, the coating may include copper or an alloy thereof having a thickness of about 0.1 to 10 micrometers. As yet another example, the coating may include an aluminum-silicon alloy having a thickness of up to about 20 micrometers, such as about 1 to 20 micrometers, such as about 10 to 20 micrometers. In some examples, the coatings may be applied by electroplating or hot dipping processes.

In some examples, the cold plates 30, 130, 630, 730 may include one or more layers configured to promote thermal transfer between adjacent channels. For example, the cold plates 30, 130, 630, 730 may include one or more coatings or interlayers formed of materials having a high thermal conductivity, such as graphite. In some examples, the cold plates 30, 130, 630, 730 may include a high thermal conductivity layer disposed on a side of the non-inflated substrate that is opposite the channels (e.g., flat side). FIG. 9 is a cross-sectional view of an exemplary portion of an RESS 924 including a portion of a battery module 926, a floor panel 936 defining a portion of a housing of the RESS 924, and a cold plate 930 therebetween. The cold plate 930 includes a first substrate 942, a second substrate 944 with channels 948 formed therebetween for the flow of coolant, and a high thermal conductivity layer 964 disposed on an exterior of the first substrate 942. In some examples, a layer of supporting material 938 (e.g., a polymer foam) may optionally be disposed between portions of the cold plate 930 and the floor panel 936 to provide support in cavities between the channels 948. In some examples, a layer of a thermal interface material (TIM) 946 may be disposed between the battery module 926 and the cold plate 930.

The cold plates 30, 130, 630, 730 may be configured for use with various coolants and various liquid cooling systems. For example, the coolant can include any liquid that absorbs or transfers heat to cool or heat an associated component, such as water and/or ethylene glycol (i.e., "antifreeze"). The coolant can comprise at least one of air, nitrogen, water, ethylene glycol, ethanol, methanol, or ammonia. When in use, a liquid flow rate of a liquid coolant through the channels may be about 1 to 30 liters per minute, and a gas flow rate of a gas coolant through the channels may be about 200 to 300 meters cubed per hour.

The systems and methods disclosed herein provide various benefits over certain existing systems and methods. For example, certain existing cold plates for RESSs are formed of relatively expensive materials such as aluminum, are produced using complicated and expensive processes such as brazing, and must be secured relative to a housing of the RESS with fasteners or the like. In contrast, the cold plates disclosed herein may be formed of relatively inexpensive materials such as steel, do not require brazing, and may be integrated into the housing of the RESS such as by welding or by defining a portion of the housing.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method, comprising:
welding together a first substrate and a second substrate with weld lines;
inflating portions of at least the second substrate between the weld lines to form a network of channels between the first substrate and the second substrate and thereby produce a cold plate;
installing the cold plate to be in thermal contact with an apparatus that produces heat during operation thereof, wherein the apparatus includes a housing and the cold plate is welded to a portion of the housing or defines a portion of the housing; and
coupling the cold plate to a liquid cooling system configured to supply a coolant to the network of channels to remove the heat from the apparatus.

2. The method of claim 1, wherein installing the cold plate includes welding the cold plate to a panel of the housing of the apparatus.

3. The method of claim 2, wherein the apparatus is a rechargeable energy storage system (RESS) of a vehicle that includes at least a first battery module, and the cold plate is welded to a floor panel of the housing of the RESS or to a housing of the first battery module.

4. The method of claim 1, wherein the cold plate defines a panel of the housing of the apparatus.

5. The method of claim 4, wherein the apparatus is a rechargeable energy storage system (RESS) of a vehicle, and the cold plate defines a floor panel of the housing of the RESS.

6. The method of claim 4, wherein the apparatus is a rechargeable energy storage system (RESS) of a vehicle, and the cold plate defines a cover panel of the housing of the RESS.

7. The method of claim 1, further comprising removing non-inflated areas of the second substrate prior to installing the cold plate.

8. The method of claim 1, further comprising providing a high thermal conductivity layer one a side of the first substrate opposite the network of channels to promote thermal transfer between adjacent channels of the network of channels.

9. A cold plate, comprising:
a first substrate and a second substrate welded together with weld lines, wherein portions of at least the second substrate between the weld lines are deformed to be raised relative to the first substrate and thereby form a network of channels between the first substrate and the second substrate, wherein the cold plate is configured to be installed in thermal contact with an apparatus that produces heat during operation thereof, wherein the apparatus includes a housing and the cold plate is configured to be welded to a portion of the housing or define a portion of the housing, wherein the first substrate and the second substrate are formed of steel;
an inlet configured to provide access to the network of channels, receive a coolant from a liquid cooling system, and direct the coolant to the network of channels to remove the heat from the apparatus; and
an outlet configured to provide access to the network of channels, receive the coolant from the network of channels, and direct the coolant to the liquid cooling system.

10. The cold plate of claim 9, wherein the cold plate is configured to be welded to a panel of the housing of the apparatus.

11. The cold plate of claim 10, wherein the apparatus is a rechargeable energy storage system (RESS) of a vehicle that includes at least a first battery module, and the cold plate is configured to be welded to a floor panel of the housing of the RESS or to a housing of the first battery module.

12. The cold plate of claim 9, wherein the cold plate is configured to define a panel of the housing of the apparatus.

13. The cold plate of claim 12, wherein the apparatus is a rechargeable energy storage system (RESS) of a vehicle, and the cold plate is configured to define a floor panel of the housing of the RESS.

14. The cold plate of claim 12, wherein the apparatus is a rechargeable energy storage system (RESS) of a vehicle, and the cold plate is configured to define a cover panel of the housing of the RESS.

15. The cold plate of claim 9, wherein the second substrate does not include non-inflated areas outside of the weld lines.

16. The cold plate of claim 9, further comprising a high thermal conductivity layer on a side of the first substrate opposite the network of channels that is configured to promote thermal transfer between adjacent channels of the network of channels.

17. A vehicle, comprising:
a rechargeable energy storage system (RESS) having at least one battery and a housing enclosing the at least one battery;
a liquid cooling system having a coolant circuit, a pump configured to propel a coolant through the coolant circuit, and a heat exchanger for removing heat from the coolant; and
a cold plate in thermal contact with the RESS and fluidically coupled with the coolant circuit, wherein the cold plate includes:
a first substrate and a second substrate welded together with weld lines, wherein portions of at least the second substrate between the weld lines are deformed to be raised relative to the first substrate and thereby form a network of channels between the first substrate and the second substrate, wherein the cold plate is configured to be welded to a portion of the housing or define a portion of the housing of the RESS, wherein the first substrate and the second substrate are formed of steel;
an inlet configured to provide access to the network of channels, receive the coolant from the liquid cooling system, and direct the coolant to the network of channels to remove heat from the at least one battery during operation of the RESS; and
an outlet configured to provide access to the network of channels, receive the coolant from the network of channels, and direct the coolant to the liquid cooling system.

18. The vehicle of claim 17, wherein the cold plate is configured to be welded to a panel of the housing of the RESS or to a housing of a battery module of the RESS.

19. The vehicle of claim 17, wherein the cold plate is configured to define a floor panel or a cover panel of the housing of the RESS.

20. The vehicle of claim 17, wherein non-inflated areas of the second substrate of the cold plate are removed and the cold plate includes a high thermal conductivity layer configured to promote thermal transfer between adjacent channels of the network of channels.
